(19) United States
(12) Patent Application Publication
(10) Pub. No.: US 2025/0304194 A1
(43) Pub. Date: Oct. 2, 2025

(54) ENDLESS TRACK FOR TRACK SYSTEM AND TRACK SYSTEM HAVING SAME

(71) Applicant: SOUCY INTERNATIONAL INC., Drummondville (CA)

(72) Inventors: Magella BEDARD, Drummondville (CA); Francois LAFLAMME, St-Germain-De-Grantham (CA); Marc-Antoine LEBLANC, Drummondville (CA); Remi HAMELIN, Trois-Rivieres (CA); Olivier LECLERC, Drummondville (CA)

(21) Appl. No.: 18/866,120

(22) PCT Filed: May 31, 2023
(86) PCT No.: PCT/CA2023/050746

§ 371 Date: Nov. 15, 2024

Related U.S. Application Data
(60) Provisional application No. 63/347,667, filed on Jun. 1, 2022.

(51) Int. Cl. B62D 55/24; B62D 55/10; B62D 55/14

(52) U.S. Cl. CPC B62D 55/244; B62D 55/10; B62D 55/14

(57) ABSTRACT

Endless tracks for track systems and track systems having endless tracks are disclosed. One endless track includes a carcass, inner lugs extending from an inner surface of the carcass and outer lugs extending from an outer surface of the carcass. The outer lugs each include first and second outer lugs portions. The first outer lug portion, which extends from the outer surface to a junction height, has a junction interface at the junction height, has an outer lug reinforcing member, defines a base radius and is made of a first material. The second outer lug portion, which extending from the junction interface to an outer lug height, has an engaging surface at the outer lug height, and is made of a second material different from the first material. Each outer lug also has a draft angle defined by a longitudinal side thereof and a projection of its engaging surface.

### CROSS-REFERENCE TO RELATED APPLICATION

The present application claims priority to U.S. Provisional Application No. 63/347,667, filed Jun. 1, 2022 entitled “Endless Track for Track System and Track System Having Same”, which is incorporated by reference herein in its entirety.

### TECHNICAL FIELD

The present application generally relates to endless tracks and track systems having endless tracks.

### BACKGROUND

Certain vehicles, such as, for example, heavy vehicles such as military vehicles, agricultural vehicles (e.g., harvesters, combines, tractors, etc.), construction vehicles (e.g., trucks, front-end loaders, etc.), forestry vehicles and exploratory vehicles are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces and, as these vehicles are generally heavy, the tires may compact the ground surface in an undesirable way owing to the weight of the vehicle.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable vehicles to be used in wet field conditions as opposed to its wheeled counterpart. In other conditions, track systems enable vehicles to be used in low traction terrains.

Conventional track systems do, however, present some inconveniences. Some endless tracks of conventional track systems can have low durability, in part due to the high loads to which they can be subjected to. Specifically, endless tracks of conventional track systems can particularly have low durability at their outer lugs.

Therefore, there is a desire for a track system that could mitigate at least some of the above-mentioned issues.

### SUMMARY

It is an object of the present technology to ameliorate at least some of the inconveniences present in the prior art.

According to one aspect of the present technology, there is provided an endless track for a track system of a vehicle. The endless track includes a carcass, a plurality of inner lugs and a plurality of outer lugs. The carcass has an inner surface and an outer surface opposite to the inner surface. The plurality of inner lugs extend from the inner surface and are longitudinally spaced along a longitudinal center plane of the endless track, and the plurality of outer lugs extend from the outer surface and are longitudinally spaced along the outer surface. Each one of the plurality of outer lugs includes a first outer lug portion extending from the outer surface to a junction height. The first outer lug portion defines a base radius, has a junction interface at the junction height. The first outer lug portion is made of a first material, and includes an outer lug reinforcing member. Each one of the plurality of outer lugs also includes a second outer lug portion extending from the junction interface of the first outer lug portion to an outer lug height. The second outer lug portion has an engaging surface at the outer lug height, and is made of a second material that is different from the first material. Each one of the plurality of outer lugs also includes a draft angle defined by a longitudinal side of the one of the plurality of outer lugs and a projection of the engaging surface of the one of the plurality of outer lugs.

In some embodiments, the outer lug reinforcing member has an outer lug reinforcing member height, and wherein ratio of the outer lug reinforcing member height over the junction height is at least about 0.75.

In some embodiments, the ratio of the outer lug reinforcing member height over the junction height is at least about 0.8.

In some embodiments, the ratio of the outer lug reinforcing member height over the junction height is at least about 0.85.

In some embodiments, the ratio of the outer lug reinforcing member height over the junction height is at least about 0.90.

In some embodiments, the ratio of the outer lug reinforcing member height over the junction height is at least about 0.95.

In some embodiments, the ratio of the outer lug reinforcing member height over the junction height is between about 0.75 and about 0.95.

In some embodiments, a ratio of the junction height over the outer lug height is about 0.5

In some embodiments, a ratio of the junction height over the outer lug height is about 2/3.

In some embodiments, each one of the plurality of outer lugs has, at a vertical center of the outer lug reinforcing member, a first outer lug length measured generally parallel to the longitudinal center plane of the endless track, and each one of the plurality of outer lug reinforcing members has, at the vertical center thereof, a first outer lug reinforcing member length measured generally parallel to the longitudinal center plane of the endless track. A ratio of the first outer lug length over the first outer lug reinforcing member length is about 0.49.

In some embodiments, each one of the plurality of outer lugs has, at a first end of the outer lug reinforcing member, a second outer lug length measured generally parallel to the longitudinal center plane of the endless track, and each one of the plurality of outer lug reinforcing members has, at the first end thereof, a second outer lug reinforcing member length measured generally parallel to the longitudinal center plane of the endless track. A ratio of the second outer lug length over the second outer lug reinforcing member length is about 0.46.

In some embodiments, each one of the plurality of outer lugs has, at a second end of the outer lug reinforcing member, a third outer lug length measured generally parallel to the longitudinal center plane of the endless track, and each one of the plurality of outer lug reinforcing members has, at the second end thereof, a third outer lug reinforcing member length measured generally parallel to the longitudinal center plane of the endless track. A ratio of the third outer lug length over the outer lug reinforcing member length is about 0.37.

In some embodiments, the outer lug reinforcing member length is at most 50 millimetres.

In some embodiments, the outer lug reinforcing member is made of a composite material.

In some embodiments, the outer lug reinforcing member is at least partially wrapped with a fabric.

In some embodiments, a cross-sectional profile of the outer lug reinforcing member taken along the longitudinal center plane of the endless track generally has a hexagonal shape.

In some embodiments, a cross-sectional profile of the outer lug reinforcing member taken along the longitudinal center plane of the endless track generally has an oblong shape.

In some embodiments, the draft angle is greater than about 6 degrees.

In some embodiments, the draft angle is greater than about 8 degrees.

In some embodiments, the draft angle is about 9 degrees.

In some embodiments, a virtual center of the base radius of one of the plurality of outer lugs is coincident with a virtual center of the base radius of another one of the plurality of outer lugs adjacent to the one of the plurality of outer lugs.

In some embodiments, the first material has a first modulus of elasticity, the second material has a second modulus of elasticity, and the first modulus of elasticity is smaller than the second modulus of elasticity.

In some embodiments, the first material has a first hardness value, the second material has a second hardness value, and the second hardness value is greater than the first hardness value.

In some embodiments, the first outer lug portion is an underlying outer lug portion and the second outer lug portion is an overlying outer lug portion.

In some embodiments, the second lug portion is made of stacked layers of the second material.

In some embodiments, the second lug portion is pre-molded.

In some embodiments, the second lug portion is extruded.

In some embodiments, the longitudinal side is a first longitudinal side and a second longitudinal side, and at least one of the first and second longitudinal sides defining an at least partially arcuate profile.

In some embodiments, at least one outer lug of the plurality of outer lugs are shaped like a chevron.

In some embodiments, at least some of the plurality of outer lugs are longitudinally aligned with some of the plurality of inner lugs.

In some embodiments, the plurality of inner lugs is a plurality of central drive lugs.

In some embodiments, the vehicle is a heavy vehicle.

In some embodiment, the endless track further includes a plurality of longitudinal reinforcing members.

In some embodiments, the plurality of longitudinal reinforcing members is at least one of a plurality of cables and a plurality of fabrics.

In some embodiments, the endless track further includes a plurality of inner lug reinforcing members, each one of the plurality of inner lug reinforcing members being disposed in one of the plurality of inner lugs.

According to another aspect of the present technology, there is provided a track system for a heavy vehicle, the track system including a frame, a plurality of wheel assemblies connected to the frame, and the endless track according to the above aspect or according to the above aspect and one or more of the above embodiments surrounding the plurality of wheel assemblies.

According to another aspect of the present technology, there is provided an endless track for a track system of a vehicle, the endless track including a carcass, a plurality of inner lugs and a plurality of outer lugs. The carcass has an inner surface and an outer surface opposite to the inner surface. The plurality of inner lugs extend from the inner surface and are longitudinally spaced along the inner surface of the carcass. The plurality of outer lugs extend from the outer surface and are longitudinally spaced along the outer surface. Each one of the plurality of outer lugs includes a first outer lug portion extending from the outer surface to a junction height. The first outer lug portion defines a base radius and has a junction interface at the junction height. The first outer lug portion is made of a first material. Each one of the plurality of outer lugs also includes a second outer lug portion extending from the junction interface of the first outer lug portion to an outer lug height. The outer lug has an engaging surface at the outer lug height, and is made of a second material different from the first material. A virtual center of the base radius of one of the plurality of outer lugs is coincident with a virtual center of the base radius of another one of the plurality of outer lugs adjacent to the one of the plurality of outer lugs.

In some embodiments, the endless track further includes a plurality of outer lug reinforcing members each having an outer lug reinforcing member height, one of the plurality of outer lug reinforcing member being disposed in one of the plurality of outer lugs.

In some embodiments, a ratio of the outer lug reinforcing member height over the junction height is at least about 0.75.

In some embodiments, the ratio of the outer lug reinforcing member height over the junction height is at least about 0.8.

In some embodiments, the ratio of the outer lug reinforcing member height over the junction height is at least about 0.85.

In some embodiments, the ratio of the outer lug reinforcing member height over the junction height is at least about 0.90.

In some embodiments, the ratio of the outer lug reinforcing member height over the junction height is at least about 0.95.

In some embodiments, each one of the plurality of outer lugs has, at a vertical center of the outer lug reinforcing member, an outer lug length measured generally parallel to the longitudinal center plane of the endless track, and each one of the plurality of outer lug reinforcing members has, at the vertical center thereof, an outer lug reinforcing member length measured generally parallel to the longitudinal center plane of the endless track. A ratio of the outer lug length over an outer lug reinforcing member length is about 0.47.

In some embodiments, each one of the plurality of outer lugs has, at a first end of the outer lug reinforcing member, a second outer lug length measured generally parallel to the longitudinal center plane of the endless track, and each one of the plurality of outer lug reinforcing members has, at the first end thereof, a second outer lug reinforcing member length measured generally parallel to the longitudinal center plane of the endless track. A ratio of the second outer lug length over the second outer lug reinforcing member length is about 0.41.

In some embodiments, each one of the plurality of outer lugs has, at a second end of the outer lug reinforcing member, a third outer lug length measured generally parallel to the longitudinal center plane of the endless track, and each one of the plurality of outer lug reinforcing members has, at the second end thereof, a third outer lug reinforcing member length measured generally parallel to the longitudinal center plane of the endless track. A ratio of the third outer lug length over the outer lug reinforcing member length is about 0.45.

In some embodiments, the outer lug reinforcing member length is at most about 50 millimetres.

In some embodiments, a ratio of the junction height over the outer lug height is about 0.5.

In some embodiments, a ratio of the junction height over the outer lug height is about 2/3.

In some embodiments, the outer lug reinforcing member is made of a composite material.

In some embodiments, the outer lug reinforcing member is at least partially wrapped with a fabric.

In some embodiments, a cross-section of the outer lug reinforcing member taken along the longitudinal center plane of the endless track generally has a hexagonal shape.

In some embodiments, a cross-section of the outer lug reinforcing member taken along the longitudinal center plane of the endless track generally has an oblong shape.

In some embodiments, each one of the plurality of outer lugs has a draft angle defined by a side of the one of the plurality of outer lugs and a projection of the engaging surface of the one of the plurality of outer lugs.

In some embodiments, the draft angle is greater than about 6 degrees.

In some embodiments, the draft angle is greater than about 8 degrees.

In some embodiments, the draft angle is about 9 degrees.

In some embodiments, the first material has a first modulus of elasticity, the second material has a second modulus of elasticity, and the first modulus of elasticity is smaller than the second modulus of elasticity.

In some embodiments, the first material has a first hardness value, the second material has a second hardness value, and the second hardness value is greater than the first hardness value.

In some embodiments, the first outer lug portion is an underlying outer lug portion and the second outer lug portion is an overlying outer lug portion.

In some embodiments, the second lug portion is made of stacked layers of the second material.

In some embodiments, the second lug portion is pre-molded.

In some embodiments, the second lug portion is extruded.

In some embodiments, each one of the plurality of first outer lug portions has a first longitudinal side and second longitudinal side, and at least one of the first and second longitudinal sides defining an arcuate profile.

In some embodiments, at least some of the outer lugs of the plurality of outer lugs are shaped like a chevron.

In some embodiments, at least some of the plurality of outer lugs are longitudinally aligned with some of the plurality of inner lugs.

In some embodiments, the plurality of inner lugs is a plurality of central drive lugs.

In some embodiments, the vehicle is a heavy vehicle.

In some embodiments, the endless track further includes a plurality of longitudinal reinforcing members.

In some embodiments, the plurality of longitudinal reinforcing members is one of a plurality of cables and a plurality of fabrics.

In some embodiments, the endless track further includes a plurality of inner lug reinforcing members, each one of the plurality of inner lug reinforcing members being disposed in one of the plurality of inner lugs.

According to another aspect of the present technology, there is provided a track system for a heavy vehicle. The track system includes a frame, a plurality of wheel assemblies connected to the frame, and the endless track according to the above aspect or according to the above aspect and one or more of the above embodiments surrounding the plurality of wheel assemblies.

According to another aspect of the present technology, there is provided an endless track for a track system of a vehicle. The endless track includes a carcass, a plurality of inner lugs and a plurality of outer lugs. The carcass has an inner surface and an outer surface opposite to the inner surface. The plurality of inner lugs extend from the inner surface and are longitudinally spaced along a longitudinal center plane of the endless track. The plurality of outer lugs extend from the outer surface and are longitudinally spaced along the outer surface. Each one of the plurality of outer lugs includes a first outer lug portion extending from the outer surface to a junction height. The first outer lug portion has a junction interface at the junction height. The first outer lug portion is made of a first material, and includes an outer lug reinforcing member. Each one of the plurality of outer lugs also includes a second outer lug portion extending from the junction interface of the first outer lug portion to an outer lug height. The second outer lug portion has an engaging surface at the outer lug height. The second outer lug portion is made of a second material different from the first material. The outer lug reinforcing member has an outer lug reinforcing member height, and a ratio of the outer lug reinforcing member height over the junction height is at least about 0.75.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 15%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track system and components in relation thereto, such as “vertical”, “horizontal”, “forwardly”, “rearwardly”, “left”, “right”, “above” and “below”, are as they would be understood by a driver of a vehicle to which the track system is connected, in which the driver is sitting in the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A is a perspective view of a military vehicle having track systems that each have an endless track according to an embodiment of the present technology;

FIG. 1B is a right side elevation view of a harvester having track systems that each have an endless track according to an embodiment of the present technology;

FIG. 2A is a perspective view of a portion of the endless track of FIG. 1A;

FIG. 2B is a perspective view of a section of the portion of the endless track of FIG. 2A, with part of the endless track being shown in transparency;

FIG. 3 is a schematic cross-sectional view of part of the portion of the endless track of FIG. 2A taken across a longitudinal center plane of the portion of the endless track;

FIG. 4 is a close-up of the portion of the endless track of FIG. 3; and

FIG. 5 is a close-up of a portion of an alternative embodiment of an endless tack.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology relates to various embodiments of an endless track, which will be described with reference to a track system. The endless track according to embodiments of the present technology, includes a carcass, inner lugs and outer lugs. The outer lugs have been optimized to increase durability of the endless track. Notably, the outer lugs each have two lug portions made of two different material, with an underlying lug portion being more resiliently deformable than an overlying lug portion, and the overlying lug portion having a higher hardness than the underlying lug portion. Furthermore, the outer lugs have been spaced and shaped in such a manner that the durability of the endless track has been enhanced.

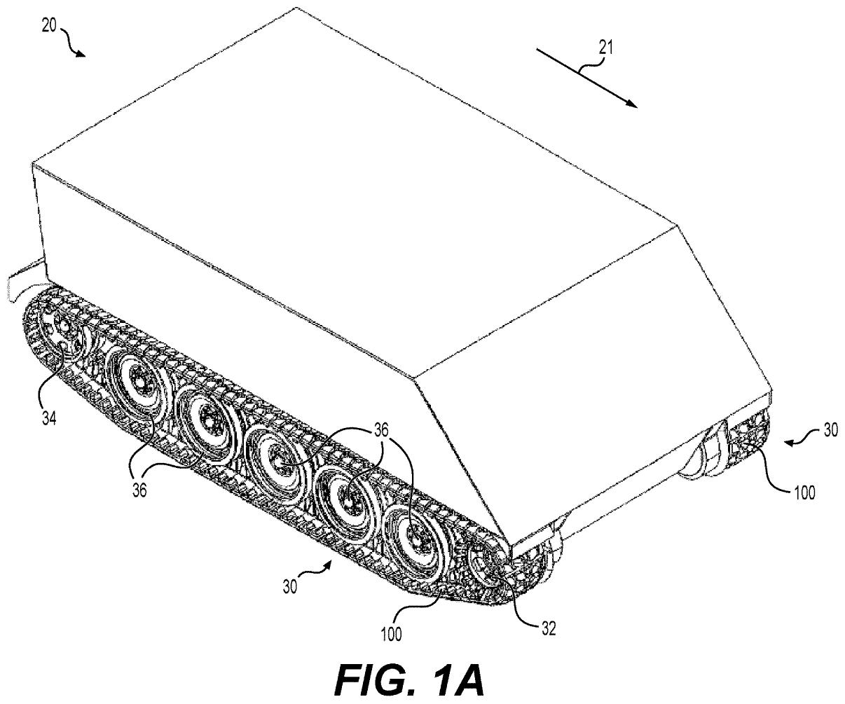

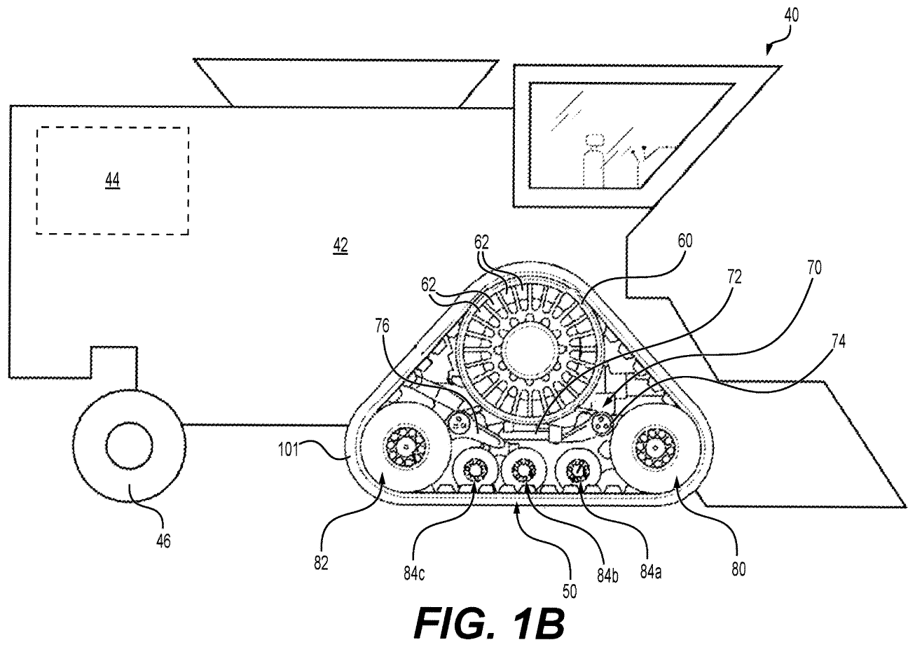

Referring to FIG. 1A, the present technology will be described with reference to a military vehicle 20, which is a heavy vehicle. Specifically, the military vehicle 20 is an armored personnel carrier 20, the forward direction of which is indicated by arrow 21. The military vehicle 20 has, on either side thereof, track systems 30. Each of the track systems 30 has a sprocket wheel assembly 32 mounted to a front end of the military vehicle 20, an idler wheel assembly 34 mounted at a rear end of the military vehicle 20 and five road wheel assemblies 36 mounted along a length of the military vehicle 20. It is contemplated that there could be more or less than five road wheel assemblies. Each of the track systems 30 also includes an endless track 100 that surrounds the sprocket wheel assembly 32, the idler wheel assembly 34 and the road wheel assemblies 36.

The sprocket wheel assembly 32 is generally configured to engage the endless track 100 and to transmit motive power from an engine (not shown) of the military vehicle 10 to the endless track 100. The idler wheel assembly 34 is configured to adjust tension and to guide the endless track 100. The road wheel assemblies 36 are generally configured to guide a lower run portion of the endless track 100 which engages the ground during use.

It is contemplated that the present technology could be used with vehicles other than military vehicles. For example, the present technology could be used with other agricultural vehicles such as tractors, with industrial vehicles such as bulldozers, skid-steer loaders, excavators and compact track loaders, with military vehicles such as tanks, with utility vehicles, with exploratory vehicles and/or with all-terrain vehicles such as, side-by-side vehicles or utility-terrain vehicles. It is also contemplated that the present technology could be used with trailers or other unpowered vehicles.

For instance, referring to FIG. 1B, the present technology is shown used with a harvester 40. The harvester 40 has a frame 42 that houses an engine 44 (shown schematically). The harvester 40 also has left and right rear wheels 46 and left and right track systems 50 (only right rear wheel 46 and right track system 50 are shown in the accompanying Figures). It is contemplated that in some embodiments, the harvester 40 could have more than two track systems. The engine 44 is operatively connected to left and right track systems 50. It is contemplated that in some embodiments, the engine 44 could be operatively connected to the rear wheels 46.

Still referring to FIG. 1B, the track system 50 has a sprocket wheel assembly 60 that is operatively connected to an axle (not shown) of the harvester 40, such that when the axle rotates, the sprocket wheel assembly 60 also rotates, thereby driving the track system 50. It is contemplated that in some embodiments, the sprocket wheel assembly 60 could be configured to connect to a non-driving axle of a vehicle. The sprocket wheel assembly 60 defines a plurality of recesses 62, circumferentially, on a periphery of the sprocket wheel assembly 60. The recesses 62 are configured to engage lugs 104 provided on an inner surface 110 of an endless track 101.

The track system also has a frame 70 that is operatively connected to the sprocket wheel assembly 60 and that is disposed laterally inwardly therefrom. It is contemplated that in other embodiments, the frame 70 could be disposed laterally outwardly to the sprocket wheel assembly 60. In other embodiments, the frame 70 could be laterally aligned with the sprocket wheel assembly 60. The frame 70 has a main frame 72, a leading frame member 74 and a trailing frame member 76 where the leading and trailing frame members 74, 76 are pivotally connected to the main frame 72. It is understood that the frame 70 could differ from the above description without departing from the scope of the present technology. For example, in some embodiments, the frame 70 could be configured to not have any pivotally connected member.

The track system 50 further includes wheel assemblies, which include, in addition to the sprocket wheel assembly 60, a front idler wheel assembly 80, a rear idler wheel assembly 82 and three support wheel assemblies 84a, 84b, 84c that are disposed longitudinally between the front and rear idler wheel assemblies 80, 82. It is contemplated that in some embodiments, the track system 50 could have more or less than three support wheel assemblies.

The front idler wheel assembly 80 and the support wheel assembly 84a are rotationally connected to the leading frame member 74. The support wheel assemblies 84b, 84c are connected to form a tandem 86 which, in turn, is pivotally connected to the trailing frame member 76. The rear idler wheel assembly 82 is also rotationally connected to the trailing frame member 76. Thus, the track system 50 can, to some extent, conform to encountered obstacles.

Each one of the front and rear idler wheel assemblies 80, 82, and the support wheel assemblies 84a, 84b, 84c has two laterally spaced wheels, such that each one of the front and rear idler wheel assemblies 80, 82, and the support wheel assemblies 84a, 84b, 84c has left and right wheels (only right wheel of each of the wheel assemblies is shown in FIG. 1B). It is contemplated that in some embodiments, one or more of the front and rear idler wheel assemblies 80, 82, and the support wheel assemblies 84a, 84b, 84c could be configured to have a single wheel or three or more wheels in the lateral direction.

It is contemplated that in some embodiments, the track system 50 could include a tensioner that is configured to adjust tension in the endless track 101.

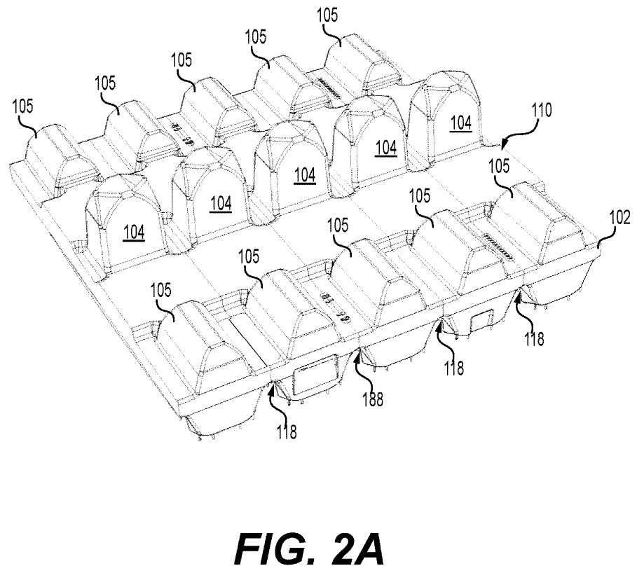

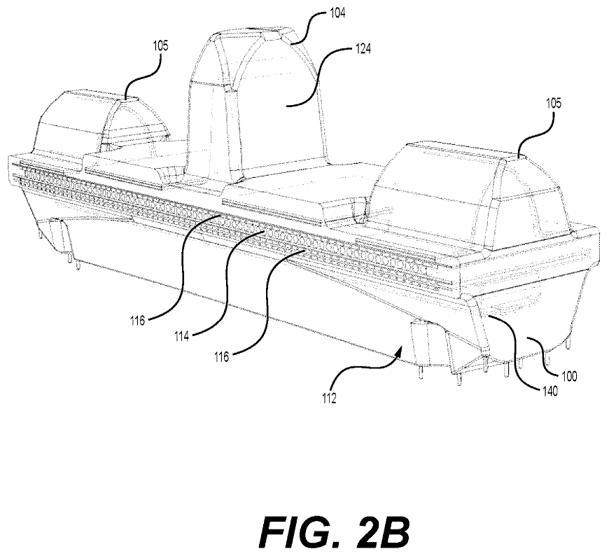

With reference to FIGS. 2A, 2B, 3 and 4, a first embodiment of the endless tracks 100, 101 will now be described. Since the endless tracks 100, 101 are similar, only the endless track 100 will be described herewith with reference to the military vehicle 20. The endless track 100 includes a carcass 102, a plurality of inner lugs 104 and a plurality of outer lugs 106.

The carcass 102 has the inner surface 110 which is engageable with the sprocket wheel assembly 32, the idler wheel assembly 34 and the road wheel assemblies 36 (or the front and rear idler wheel assemblies 80, 82 and with the support wheel assemblies 84a, 84b, 84c in the case of the endless track 101). The carcass 102 also has an outer surface 112 that is opposite to the inner surface 110, and that is engageable with a ground surface. Embedded in the carcass 102, between the inner and outer surfaces 110, 112, the endless track 100 has longitudinally extending reinforcing cables 114 and reinforcing sheets 116 that surround the reinforcing cables 114. Other configurations are contemplated. For example, in some instances, the reinforcing sheets 116 could simply be disposed above and below the reinforcing cables 114. It is contemplated that in other embodiments, the extending reinforcing cables 114 and the reinforcing sheets 116 could include other longitudinal reinforcing members. It is contemplated that in some embodiments, the reinforcing sheets 116 could be omitted. The reinforcing cables and sheets 114, 116 are configured to generally distribute loads along the carcass, and/or limit longitudinal elongation of the carcass 102. In other words, the reinforcing cables and sheets 114, 116 can reinforce the endless track 100, which can assist in reducing the likelihood of the endless track 100 from being torn and/or damaged, thereby prolonging life of the endless track 100.

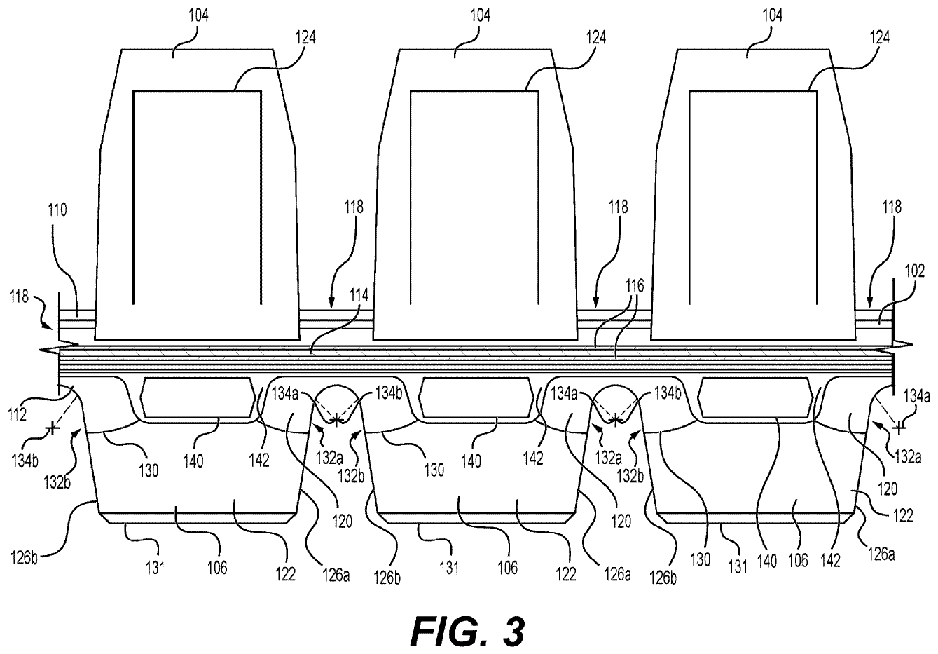

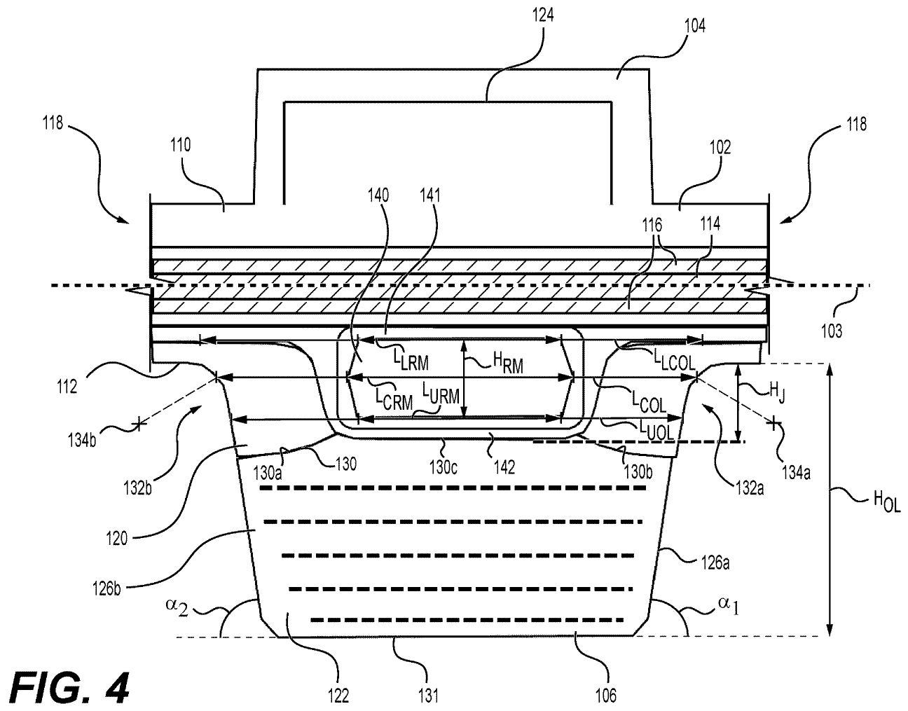

In some embodiments, the carcass 102 is made of an elastomeric material. It is contemplated that the elastomeric material could be a polymeric material such as, for example, rubber. Thus, the carcass 102 is flexible, thereby enabling it to conform to obstacles and/or components of the track system 30 such as the sprocket wheel assembly 32. Specifically, the carcass 102 has a plurality of flexible portions 118 extending between the inner and outer surfaces 110, 112. Each one of the plurality of flexible portions 118 is disposed longitudinally between two adjacent inner lugs 104 and between two adjacent outer lugs 106 (the inner and outer lugs 104, 106 are generally longitudinally aligned). Each one of the flexible portions 118, as shown in FIGS. 3 and 4 has a smaller cross-sectional height (i.e., less material) than elsewhere along the endless track 100. When overcoming obstacles, and/or conforming to one of the plurality of wheel assemblies, the endless track 100 can deform due to its resilient nature, especially at the flexible portions 118.

Focussing first on the inner surface 110, the endless track 100 includes the plurality of inner lugs 104, which are configured to engage with the sprocket wheel assembly 32. The inner lugs 104 extend from the inner surface 110 and are longitudinally spaced along a longitudinal center plane of the endless track 100. In the present embodiment, the inner lugs 104 are central drive lugs, such that the inner lugs 104 are generally laterally centered relative to the endless track 100. It is contemplated that in other embodiments, the inner lugs 104 could be provided in two laterally spaced sets of longitudinally spaced lugs. In some embodiments, the inner lugs 104 could also act as guiding lugs. In the present embodiment, each one of the plurality of inner lugs 104 has a reinforcing member 124 embedded therein for strengthening the respective inner lug 104, and reduce likelihood of the lugs 104 from being damaged. Additionally, the presence of the reinforcing members 124 can also rigidify the lugs 104, which can assist in reducing “tooth skipping” during engagement with the sprocket wheel assembly 32. Indeed, the inner lugs 104, when engaging with the sprocket wheel assembly 32, are subjected to high loads, particularly in the case of heavy vehicles. In some embodiments, the reinforcing members 124 could be omitted. It is to be noted that in certain cases, the shape of the reinforcing members 124 could impact the shape of the inner lugs 104, such that the reinforcing members 124 and the inner lugs 104 would have similar shapes.

The inner surface 110 also has lateral lugs 105 disposed on either lateral side of the endless track 100. The lateral lugs 105, which extend from the inner surface 110, are longitudinally spaced along the longitudinal center plane of the endless track 100.

With continued reference to FIGS. 2A, 2B, 3 and 4, focus will now be shifted to the outer surface 112. The endless track 100 includes the plurality of outer lugs 106 which is engageable to the ground surface. As will be described in greater detail below, the shape of the outer lugs 106 can change from one embodiment to another without departing from the scope of the present technology. In some embodiments, the shape of the outer lugs 106 could change to depending on the ground surface which is to be engaged by the endless track 100. The outer lugs 106 extend from the outer surface 112, away therefrom, and are longitudinally spaced along the longitudinal center plane of the endless track 100. In the present embodiment, each one of the outer lugs 106 is longitudinally aligned with one of the inner lugs 104. It is contemplated, however, that in some embodiments, the inner and outer lugs 104, 106 could be longitudinally offset from one another. Additionally, each one of the outer lugs 106 extends laterally along an entirety of a width of the endless track 100. It is contemplated that in some embodiments, the outer lugs 106 could extend along only a portion of the width of the endless track 100. In some embodiments, the outer lugs 106 could have varying width (e.g., one outer lug 106 is wider than another outer lug 106). In other embodiments, a shape of the outer lugs 106 could vary. The spacing and width of the outer lugs 106 could vary depending on type of ground surface on which the endless track 100 is to be used.

The outer lugs 106 will now be described in greater detail, however since, the outer lugs 106 are similar to one another, only one outer lug 106 will be described herewith.

The outer lug 106 has an underlying outer lug portion 120 and an overlying outer lug portion 122 that extends from the underlying outer lug portion 120. The present configuration of the underlying and overlying outer lug portions 120, 122, as will be described below, can increase durability of the endless track 100.

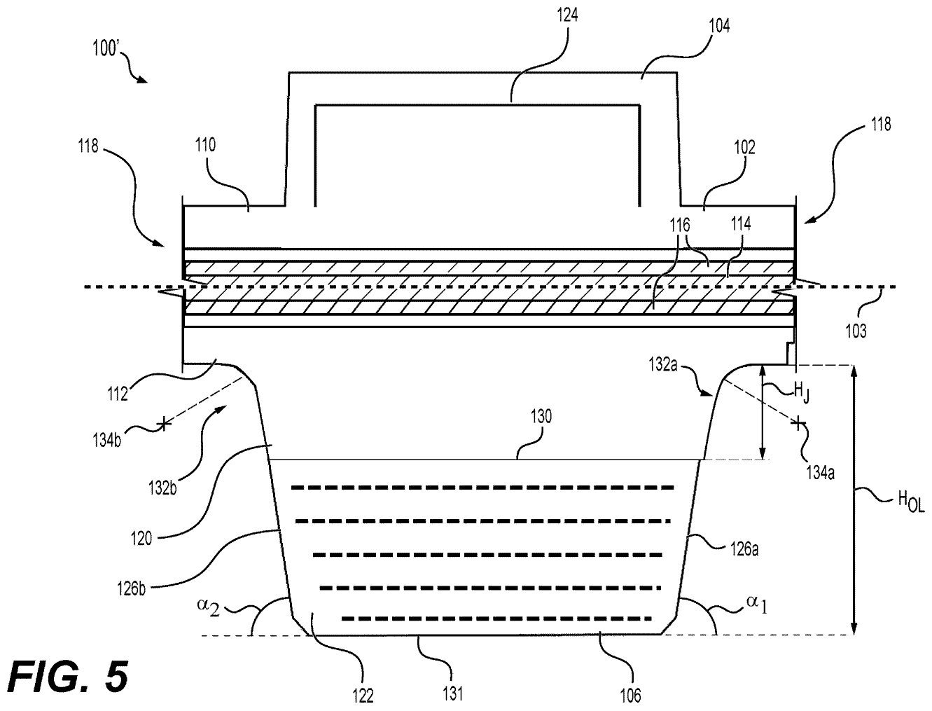

The underlying outer lug portion 120 extends from the outer surface 112 to a junction height H_{J} of the outer lug 106. A junction interface 130 is formed at the junction height H_{J} between the underlying outer lug portion 120 and the overlying outer lug portion 122. In the present embodiment, the junction interface 130 has two arcuate sections 130a, 130b and a generally horizontal section 130c extending therebetween. It is contemplated however, that in some embodiments of the endless track 100, namely endless track 100′ shown in FIG. 5, the junction interface 130 could be one generally horizontal section. It is contemplated that in other embodiments, the junction interface 130 could be shaped differently.

The underlying outer lug portion 120 is made of a first elastomeric material which has a first modulus of elasticity and a first hardness value. In the present embodiment, the underlying outer lug portion 120 is pre-molded. In yet other embodiments, the underlying outer lug portion 120 could be extruded.

The overlying outer lug portion 122 extends from the junction interface 130 to an outer lug height H_{OL}, and has an engaging surface 131 at the outer lug height H_{OL}. The engaging surface 131 is for engaging the ground surface.

The overlying outer lug portion 122 is made of a second elastomeric material, which has a second modulus of elasticity and a second hardness value. In the present embodiment, the overlying outer lug portion 122 is made of a plurality of stacked layers of the second material. In other embodiments, the overlying outer lug portion 122 could be pre-molded. In yet other embodiments, the overlying outer lug portion 122 could be extruded.

The first and second elastomeric material are different. The first and second moduli of elasticity and the first and second hardness values are also different. In the present embodiment, the first elastomeric material is more resiliently deformable than the second elastomeric material, and the second elastomeric material has a higher hardness than the first elastomeric material. As such, the overlying outer lug portion 122 (part of the outer lug 106 engaging with the ground) remains hard, which can enhance resistance to fissuring (e.g., cracking). On the other hand, the underlying outer lug portion 120 (part of the outer lug 106 that, to some extent, deforms due to loads subjected to the outer lug 106 and deforms to conform to the shape of components of the track system 30 such as the sprocket wheel assembly 32), is more resiliently deformable, which can enhance the extent of which the endless track 100 can flex around components and/or obstacles. Thus, as a whole, durability of the endless track 100 is increased.

The underlying and overlying outer lug portions 120, 122 are configured so that a ratio of the junction height H_{J} relative to the outer lug height H_{OL} allows for an increase in the amount of first elastomeric material used at the base of the underlying outer lug portions 120, which can enhance durability of the endless track 100. Thus, the selected position of the junction height H_{J} relative to the outer lug height H_{OL} can enhance durability of the endless track 100 by increasing the amount of first elastomeric material where the endless track 100 flexes (e.g., deforms). In some embodiments, the ratio of the junction height H_{J} relative to the outer lug height Hon is greater than about 0.1. In some embodiments, the ratio of the junction height H_{J} relative to the outer lug height H_{OL} is greater than about 0.2. In some embodiments, the ratio of the junction height H_{J} relative to the outer lug height H_{OL} is greater than about 0.3. In some embodiments, the ratio of the junction height H_{J} relative to the outer lug height H_{OL}, is greater than about 0.4. In some embodiments, the ratio of the junction height H_{J} relative to the outer lug height H_{OL}, is greater than about 0.5. In some embodiments, the ratio of the junction height H_{J} relative to the outer lug height H_{OL} is greater than about 0.6. In some embodiments, the ratio of the junction height H_{J} relative to the outer lug height H_{OL} is greater than about 0.7.

Turning back to the underlying outer lug portion 120, the underlying outer lug portion 120 has a front base 132a and a rear base 132b. The front and rear bases 132a, 132b are rounded, such that the underlying outer lug portion 120 defines base radii. The base radii of the front and rear bases 132a, 132b are substantially identical. The base radius of the front base 132a has a front virtual center 134a, and the base radius of the rear base 132b has a rear virtual center 134b. The plurality of outer lugs 106 are spaced and configured such that the front virtual center 134a of one of the outer lugs 106 is coincident with the rear virtual center 134b of an adjacent outer lug 106. A larger base radius can assist in increasing life of the endless track 100. Notably, when the endless track 100 flexes about the flexible portion 118, a larger base radius induces a smaller deformation and a smaller stress concentration. The deformation is a compressive deformation, and a larger base radius increases material (e.g., area) sustaining the compressive loads, thereby reducing deformation. In other words, this configuration can, in certain cases, increases the amount of first elastomeric material at the front and rear bases 132a, 132b while providing sufficient flexibility. It is contemplated that in some embodiments, the front virtual center 134a of one outer lug 106 could be offset from the rear virtual center 134b of the outer lug 106 adjacent thereto. In other embodiments, the front and rear base members 132a, 132b could not be rounded.

Additionally, a front side 126a and a rear side 126b of the outer lug 106 are tapered, and have a partially arcuate profile. In the present embodiment, the shape of the outer lug 106 is influenced by the presence and the shape of an outer lug reinforcing member 140 disposed within the outer lug 106. However, in the endless track 100′ shown in FIG. 5, there is no outer lug reinforcing member 140 disposed within the outer lug 106′. As such, the shape of the outer lug 106 could vary to accommodate for various ground surfaces. For example, in endless track 100′, due to the absence of the outer lug reinforcing member 140, the outer lug 106 could be shaped like a chevron, which can, in some instances, enhance traction. In other words, the shape of the outer lug 106 is no longer limited by the outer lug reinforcing member 140.

The outer lug 106 is tapered such that a draft angle α₁ is defined by the front side 126a and a projection of the engaging surface 131, and a draft angle α₂ is defined by the rear side 126b and a projection of the engaging surface 131. In the present embodiment, the draft angles α₁, α₂ are substantially identical, but could differ in other embodiments. In some embodiments, the draft angles α₁, α₂ increase the amount of first elastomeric material at the front and rear bases 132a, 132b, which, as mentioned above, is more easily deformed, and thus, which can increase life of the endless track 100. In some embodiments, the draft angles α₁, α₂ are about 9 degrees. In some embodiments, the draft angles α₁, α₂ could be greater than about 8 degrees. In other embodiments, the draft angles α₁, α₂ could be greater than about 7 degrees. In other embodiments, the draft angles α₁, α₂ could be greater than about 6 degrees. For example, in some embodiments, the draft angles α₁, α₂ could be about 10 degrees.

In the present embodiment, the endless track 100 includes a plurality of the outer lug reinforcing members 140, where each one of the plurality outer lug reinforcing members 140 is disposed in the one of the plurality of outer lugs 106. As the plurality of outer lug reinforcing members 140 are similar, only one outer lug reinforcing member 140 will be described herewith.

The outer lug reinforcing member 140 is disposed in the underlying outer lug portion 120 of the outer lug 106, vertically below a neutral axis 103 of the carcass 102. In some embodiments, the outer lug reinforcing member 140 is embedded in the underlying outer lug portion 120 of the outer lug 106. The outer lug reinforcing member 140 is surrounded by a connecting membrane 141, which, in turn, is wrapped by a fabric 142. The connecting membrane 141 can assist in connecting the fabric 142 to the outer lug reinforcing member 140. In some embodiments, the outer lug reinforcing member 140 could only partially be wrapped by the fabric 142. In some embodiments, the fabric 142 is a coating fabric. In other embodiments, the fabric 142 is a corrugated fabric. It is contemplated that in some embodiments, the fabric 142 and/or the connecting membrane 141 could be omitted. In some embodiments, the fabric 142 being omitted can increase life of the endless track 100, because the fabric 142 being more rigid than the carcass 102 can create high deformations and/or because the fabric 142 can separate from the carcass 102 and/or from the outer lug reinforcing member 140 thereby causing problems. In embodiments where the fabric 142 is omitted, the connecting membrane 141 could help connect the outer lug reinforcing member 140 to the underlying outer lug portion 120. In some embodiments, the connecting membrane 141 could be a connecting elastomer. Additionally, the outer lug reinforcing member 140 is made of a composite material. It is contemplated that the outer lug reinforcing member 140 could be made of another material, such as, for example, steel.

The outer lug reinforcing member 140, which is generally disposed at a longitudinal center of the outer lug 106, extends along an entirety of the width of the outer lug 106. It is contemplated that in some embodiments, the outer lug reinforcing member 140 could extend along only a portion of the width of the outer lug 106.

The outer lug reinforcing member 140 has a prismatic shape. In certain instances, the outer lug reinforcing member 140 has a hexagonal shape. Specifically, the outer lug reinforcing member 106 has an oblong shape. It is contemplated that in other embodiments, the outer lug reinforcing member 140 could have another shape. For example, in some embodiments, the outer lug reinforcing member 140 could have rounded corners for reducing stress concentrations, which could extend life of the endless track 100. Specifically, the rounded corners of the outer lug reinforcing member 140 could reduce the likelihood of developing a vertical crack therein. In some embodiments, outer lug reinforcing members 140 having rounded corners could be about two times less likely to develop a vertical crack therein when compared with outer lug reinforcing members 140 having standard edges. Additionally, it can be about 8 to 10 times less likely for the outer lug reinforcing member 140 having rounded corners to break when compared with outer lug reinforcing members 140 having standard edges. The outer lug reinforcing member 140 has a reinforcing member height H_{RM}, and a reinforcing member length L_{RM}. In this particular embodiment, due to the oblong shape of the outer lug reinforcing member 140, the length of the outer lug reinforcing member 140 varies along the reinforcing member height H_{RM}, with a maximum length being at a vertical center of the outer lug reinforcing member 140. For the purposes of the present description, reference will be made to a lower end and an upper end of the outer lug reinforcing member 140, where the lower end is the end that is closer to the outer surface 112 and the upper end is the end closer to junction height H_{J}. The outer lug reinforcing member 140 has a lower reinforcing member length L_{LRM} at the lower end thereof, a center reinforcing member length L_{CRM} at the vertical center thereof, and an upper reinforcing member length L_{URM} at the upper end thereof. In the present embodiment, the lower reinforcing member length L_{LRM} is the same as the upper reinforcing member length L_{URM}. In some embodiments, the lower reinforcing member length L_{LRM} and the upper reinforcing member length L_{URM} are about 46 millimetres, and the center reinforcing member length L_{CRM} is about 50 millimetres. It is contemplated that the lower reinforcing member length L_{LRM} could be different from the upper reinforcing member length L_{URM}. In some embodiments, any one of the lower reinforcing member length L_{LRM}, the center reinforcing member length L_{CRM}, and the upper reinforcing member length L_{URM} could be, at most, about 50 millimetres. In some embodiments, any one of the lower reinforcing member length L_{LRM}, the center reinforcing member length L_{CRM}, and the upper reinforcing member length L_{URM} could be about 45 millimetres, 50 millimeters, about 51 millimetres or about 52 millimetres.

The length of the outer lug reinforcing member 140 has been optimized with reference to a total length of the outer lug 106 to increase flexibility of the flexible portions 118, and thus increase flexibility of the endless track 100. As such, since the endless track 100 flexes around components and/or obstacles more easily, rolling deformations, and thus chances of fissures forming, are reduced. Also, by increasing the amount of first elastomeric material, the durability of the endless track 100 is increased. Taking the outer lug reinforcing member 140 as reference, the outer lug 106 has a lower outer lug length L_{LOL} at the lower end of the outer lug reinforcing member 140, has a center outer lug length L_{COL} at the vertical center of the outer lug reinforcing member 140, and an upper outer lug length L_{UOL} at the upper end of the outer lug reinforcing member 140. In some embodiments, the upper end of the outer lug reinforcing member 140 could be vertically above the outer surface 112, such that the upper out lug length L_{UOL} could correspond to the length of the outer lug 106. In some embodiments, the lower outer lug length L_{LOL} could be about 125 millimetres. In some embodiments, the lower outer lug length L_{LOL} could be about 123 millimetres. In some embodiments, the lower outer lug length L_{LOL} could be about 120 millimetres. In some embodiments, the lower outer lug length L_{LOL} could be about 115 millimetres. In some embodiments, the lower outer lug length L_{LOL} could be about 110 millimetres. In some embodiments, the lower outer lug length L_{LOL} could be about 105 millimetres. In some embodiments, the center outer lug length L_{COL} could be about 101 millimetres. In some embodiments, the upper outer lug length L_{UOL} could be about 99 millimetres. Other dimensions are contemplated. A ratio between the lower reinforcing member length L_{LRM} and the lower outer lug length L_{LOL} is about 0.37. In some embodiments, the ratio between the lower reinforcing member length L_{LRM} and the lower outer lug length L_{LOL} could be about 0.36, about 0.35, about 0.38 or about 0.39.

A ratio between the center reinforcing member length L_{CRM} and the center outer lug length L_{COL} is about 0.50. In some embodiments, the ratio between the center reinforcing member length L_{CRM} and the center outer lug length L_{COL} could be about 0.49, about 0.48, about 0.51 or about 0.52. A ratio between the upper reinforcing member length L_{URM} and the upper outer lug length L_{UOL} is about 0.46. In some embodiments, the ratio between the upper reinforcing member length L_{URM} and the upper outer lug length L_{UOL} could be about 0.45, about 0.44, about 0.47 or about 0.48. In some embodiments, when calculating the ratios discussed hereabove, measurement of the lengths could include the connecting membrane 141 and/or the fabric 142. In some embodiments, to minimize rolling deformation at the front and rear bases 132a, 132b, a small ratio between the center outer lug length L_{COL} and a distance between two adjacent teeth (i.e., large draft angles), and a small ratio between the center reinforcing member length L_{CRM} and the center outer lug length L_{COL} (i.e., smaller reinforcing members 124) are desired. That said, the reinforcing members 124 have to be sufficiently resistant to withstand loads of the vehicle. Thus, the reinforcing members 124 are sized to be big enough to withstand loads, but not so big as to diminish flexibility of the endless track 100.

With regard to the reinforcing member height H_{RM}, the outer lug reinforcing member 140 has been optimized with reference to the junction height H_{J} to increase durability of the endless track 100, by increasing the amount of second material (i.e., material of the overlying lug portion 122) between the outer lug reinforcing member 140 and the junction height H_{J}. By increasing the amount of second material, the durability of the profile of the outer lug 106 is increased.

As such, a ratio of the reinforcing member height H_{RM} over the junction height H_{J} is about 0.8. In other embodiments, the ratio of the reinforcing member height H_{RM} over the junction height H_{J} is about 0.85. In other embodiments, the ratio of the reinforcing member height H_{RM} over the junction height H_{J} is about 0.90. In other embodiments, the ratio of the reinforcing member height H_{RM} over the junction height H_{J} is about 0.95.

While the above described features enhance durability of the endless track 100 (i.e., increase life of the endless track 100) on their own, the combinations of the features described above are synergetic. In other words, the combinations have an impact greater than a sum of these combinations on the life of the endless track 100.

### EXAMPLE

The example below is given so as to illustrate the practice of various embodiments of the present disclosure. It is are not intended to limit or define the entire scope of this disclosure.

### Example 1: Assessment of an Endless Track

Endless tracks were prepared, and their properties were assessed. An endless track according to one embodiment of the present technology having draft angles α₁, α₂ of 9 degrees was compared to another track not having such draft angles, it was measured that the presence of draft angles α₁, α₂ of 9 degrees contributed to increasing durability of an endless track by about 103%. It was shown that the adjustment of the length of the outer lug reinforcing member was able to increase durability of an endless track by about 21% when compared with an endless track where the length of the outer lug reinforcing member 140 is not optimized to increase the amount of first elastomeric material. The alignment of the virtual centers of the base radii of two adjacent outer lugs was shown to increase durability of the endless track by about 34% when compared with an endless track where the virtual center of the base radii of two adjacent outer lugs are not aligned. It was shown that the combination of the above-mentioned features contributed to increasing the overall durability of the endless track by about 220% compared to an endless track not having the combination of these features.

Modifications and improvements to the above-described embodiments of the present invention may become apparent to those skilled in the art. The foregoing description is intended to be exemplary rather than limiting. The scope of the present invention is therefore intended to be limited solely by the appended claims.

1. An endless track for a track system of a vehicle, the endless track comprising:
a carcass having an inner surface and an outer surface opposite to the inner surface;
a plurality of inner lugs extending from the inner surface and being longitudinally spaced along a longitudinal center plane of the endless track; and
a plurality of outer lugs extending from the outer surface and being longitudinally spaced along the outer surface, each one of the plurality of outer lugs comprising:
a first outer lug portion extending from the outer surface to a junction height, the first outer lug portion defining a base radius and having a junction interface at the junction height, the first outer lug portion being made of a first material, and including an outer lug reinforcing member;
a second outer lug portion extending from the junction interface of the first outer lug portion to an outer lug height, the second outer lug portion having an engaging surface at the outer lug height, the second outer lug portion being made of a second material different from the first material; and
a draft angle defined by a longitudinal side of the one of the plurality of outer lugs and a projection of the engaging surface of the one of the plurality of outer lugs.

2. The endless track of claim 1, wherein the outer lug reinforcing member has an outer lug reinforcing member height, and wherein ratio of the outer lug reinforcing member height over the junction height is at least about 0.75.

3.-6. (canceled)

7. The endless track of claim 1, wherein a ratio of the junction height over the outer lug height is about 0.5.

8. (canceled)

9. The endless track of claim 1, wherein:
each one of the plurality of outer lugs has, at a vertical center of the outer lug reinforcing member, a first outer lug length measured generally parallel to the longitudinal center plane of the endless track;
each one of the plurality of outer lug reinforcing members has, at the vertical center thereof, a first outer lug reinforcing member length measured generally parallel to the longitudinal center plane of the endless track; and
a ratio of the first outer lug length over the first outer lug reinforcing member length is about 0.47.

10. The endless track of claim 9, wherein:
each one of the plurality of outer lugs has, at a first end of the outer lug reinforcing member, a second outer lug length measured generally parallel to the longitudinal center plane of the endless track;
each one of the plurality of outer lug reinforcing members has, at the first end of the outer lug reinforcing member, a second outer lug reinforcing member length measured generally parallel to the longitudinal center plane of the endless track; and
a ratio of the second outer lug length over the second outer lug reinforcing member length is about 0.41.

11. The endless track of claim 10, wherein:
each one of the plurality of outer lugs has, at a second end of the outer lug reinforcing member, a third outer lug length measured generally parallel to the longitudinal center plane of the endless track;
each one of the plurality of outer lug reinforcing members has, at the second end of the outer lug reinforcing member, a third outer lug reinforcing member length measured generally parallel to the longitudinal center plane of the endless track; and
a ratio of the third outer lug length over the outer lug reinforcing member length is about 0.45.

12. The endless track of claim 1, wherein the outer lug reinforcing member length is at most 50 millimetres.

13.-15. (canceled)

16. The endless track of claim 1, wherein a cross-sectional profile of the outer lug reinforcing member taken along the longitudinal center plane of the endless track generally has a hexagonal shape.

17. The endless track of claim 1, wherein a cross-sectional profile of the outer lug reinforcing member taken along the longitudinal center plane of the endless track generally has an oblong shape.

18. The endless track of claim 1, wherein the draft angle is greater than about 6 degrees.

19.-20. (canceled)

21. The endless track of claim 1, wherein a virtual center of the base radius of one of the plurality of outer lugs is coincident with a virtual center of the base radius of an other one of the plurality of outer lugs adjacent to the one of the plurality of outer lugs.

22. The endless track of claim 1, wherein the first material has a first modulus of elasticity, the second material has a second modulus of elasticity, and the first modulus of elasticity is smaller than the second modulus of elasticity.

23. The endless track of claim 1, wherein the first material has a first hardness value, the second material has a second hardness value, and the second hardness value is greater than the first hardness value.

24. The endless track of claim 1, wherein the first outer lug portion is an underlying outer lug portion and the second outer lug portion is an overlying outer lug portion.

25. The endless track of claim 1, wherein the second lug portion is made of stacked layers of the second material.

26. The endless track of claim 1, wherein the second lug portion is pre-molded.

27. The endless track of claim 1, wherein the second lug portion is extruded.

28. The endless track of claim 1, wherein the longitudinal side is a first longitudinal side and a second longitudinal side, and at least one of the first and second longitudinal sides defines an at least partially arcuate profile.

29. (canceled)

30. The endless track of claim 1, wherein at least some of the plurality of outer lugs are longitudinally aligned with some of the plurality of inner lugs.

31.-35. (canceled)

36. A track system for a heavy vehicle, the track system comprising:
a frame;
a plurality of wheel assemblies connected to the frame;
the endless track of claim 1 surrounding the plurality of wheel assemblies.

37.-73. (canceled)
